(19) United States
(12) Patent Application Publication
(10) Pub. No.: US 2016/0344688 A1
(43) Pub. Date: Nov. 24, 2016

(54) Communicating via IPv6-only Networks Using IPv4 Literal Identifiers

(71) Applicant: Apple Inc., Cupertino, CA (US)

(72) Inventors: Prabhakar Lakhera, San Jose, CA (US); Vincent Lubet, Los Altos, CA (US); David Schinazi, San Francisco, CA (US); Thomas F. Pauly, Cupertino, CA (US)

(21) Appl. No.: 14/719,889

(22) Filed: May 22, 2015

(51) Int. Cl. H04L 29/12

(52) U.S. Cl. CPC H04L 61/251; H04L 61/1511; H04L 61/2521; H04W 80/045

(57) ABSTRACT

Techniques are disclosed relating to communicating, via IPv6-only networks, with devices on IPv4 networks. In some embodiments, a mobile device stores program instructions executable to: generate a request to access a network server that specifies an IPv4 literal, query a DNS server using a reserved name to determine an IPv6 prefix, synthesize an IPv6 address using the prefix and the IPv4 literal, create a transport layer connection to the network server using the synthesized IPv6 address, and transmit multiple packets using the connection, without re-translating the IPv4 literal for the packets. These per-connection translation techniques may reduce power consumption and/or processing time relative to per-packet translation, in some embodiments.

### TECHNICAL FIELD

The present application relates to wireless devices, and more particularly to techniques for communicating, via IPv6-only networks, with devices on IPv4 networks.

### DESCRIPTION OF THE RELATED ART

Wireless communication systems are rapidly growing in usage. Further, wireless communication technology has evolved from voice-only communications to also include the transmission of data, such as Internet and multimedia content. In order to enable their wireless device to access a wireless communication network (e.g., a cellular telecommunication network) which provides such services, a user may in some cases be required to subscribe to a service provider (a “carrier”), who in turn may provide such services to the user, e.g., via a wireless communication network which they operate.

Wireless carriers generally would like to deploy pure Internet Protocol version 6 (IPv6) data networks. There are various reasons for this, including depletion of IPv4 addresses. An IPv6-only implementation will likely use NAT64/DNS64 to facilitate communication between IPv6 and IPv4 hosts in order to reach IPv4-only entities on other networks such as the Internet. In the NAT64/DNS64 scheme, when a pure IPv6 device attempts to connect to an IPv4-only host, a DNS64 server synthesizes an IPv6 address for the host (e.g., returning an AAAA record when only an A record was found for the IPv4-only host). A NAT64 server is then used to route traffic, based on a prefix of the synthesized IPv6 address. NAT64 is specified in RFC 6146, M. Bagnulo, “Stateful NAT64: Network Address and Protocol Translation from IPv6 Clients to IPv4 Servers,” April 2011, which is incorporated by reference herein in its entirety. DNS64 is specified in RFC 6147, M. Bagnulo, “DNS64: DNS Extensions for Network Address Translation from IPv6 Clients to IPv4 Servers,” April 2011, which is incorporated by reference herein in its entirety.

Unfortunately, many current applications use IPv4 literal addresses rather than hostnames. In this case, DNS is not implicated, leaving these applications unable to communicate with IPv4 hosts via pure IPv6 networks even using NAT64/DNS64. Therefore, techniques for communicating with IPv4 resources via pure IPv6 networks are desired.

### SUMMARY

Embodiments described herein relate to a user equipment device (UE) and associated techniques for communicating, via IPv6-only networks, with devices on IPv4 networks.

In some embodiments, an apparatus includes at least one antenna, one or more radios coupled to the antenna(s), one or more processing elements, and one or more memories storing program instructions that are executable to cause the apparatus to perform various operations, including to generate a request to access a network server, where the request specifies an Internet Protocol version 4 (IPv4) literal identifier of the network server. In these embodiments, the operations include to query a domain name system (DNS) server using a reserved name, to determine an IPv6 prefix usable for IPv6 address synthesis. In some embodiments, network traffic with the prefix is routable to a network address translation (NAT) server that is for routing communications between an Internet Protocol version 6 (IPv6) network of the device and an IPv4 network of the network server. In some embodiments, the operations include to synthesize an IPv6 address based on the determined IPv6 prefix and the IPv4 literal identifier, to create a transport layer connection to the network server, and to associate the transport layer connection with the synthesized IPv6 address. In some embodiments, the operations include to transmit, using the transport layer connection, multiple packets to the network server via the NAT server, and the transmitting uses the synthesized IPv6 address for each of the packets while the IPv4 literal identifier is not re-translated by the device for the different packets.

In some embodiments, a method includes generating a request to access a network server and the request specifies an Internet Protocol version 4 (IPv4) literal identifier of the network server. In these embodiments, the method includes querying a domain name system (DNS) server using a reserved name, to determine an IPv6 prefix usable for IPv6 address synthesis. In these embodiments, the method includes synthesizing an IPv6 address based on the determined IPv6 prefix and the IPv4 literal identifier, creating a network session to the network server, and associating the network session with the synthesized IPv6 address. In these embodiments, the method includes transmitting, using the network session, multiple packets to the network server via the NAT server and the transmitting uses the synthesized IPv6 address for each of the packets. In these embodiments, the IPv4 literal identifier is not re-translated for ones of the packets.

In some embodiments, a non-transitory computer-readable medium has instructions stored thereon that are executable by a computing device to perform various operations including generating a request to access a network server, that specifies an Internet Protocol version 4 (IPv4) literal identifier of the network server. In these embodiments, the operations further comprise querying a domain name system (DNS) server using a reserved name, to determine an IPv6 prefix usable for IPv6 address synthesis. In these embodiments, the operations further comprise synthesizing an IPv6 address based on the determined IPv6 prefix and the IPv4 literal identifier, creating a transport layer session to the network server, and associating the network session with the synthesized IPv6 address. In these embodiments, the operations further comprise transmitting a plurality of packets to the network server via a NAT server, using the synthesized IPv6 address, without re-translating the IPv4 literal identifier for the different packets.

### BRIEF DESCRIPTION OF THE DRAWINGS

A better understanding of the present disclosure can be obtained when the following detailed description of the embodiments is considered in conjunction with the following drawings.

FIG. 1 illustrates an exemplary mobile device according to some embodiments.

FIG. 2 illustrates exemplary communications via an IPv6-only network, according to some embodiments.

FIG. 3 illustrates exemplary DN64/NAT64 communications, according to some embodiments.

FIG. 4 illustrates exemplary translation of an IPv4 literal identifier, according to some embodiments.

FIG. 5 illustrates exemplary programming interfaces and communication layers.

FIG. 6 is an example block diagram of a mobile device, according to some embodiments.

FIG. 7 is a flow diagram illustrating a method for translating an IPv4 literal address, according to some embodiments.

While the embodiments described in this disclosure may be susceptible to various modifications and alternative forms, specific embodiments thereof are shown by way of example in the drawings and are herein described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

This specification includes references to “one embodiment,” “an embodiment,” and/or “some embodiments.” The appearances of these phrases do not necessarily refer to the same embodiment(s). Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component.

### DETAILED DESCRIPTION OF THE EMBODIMENTS

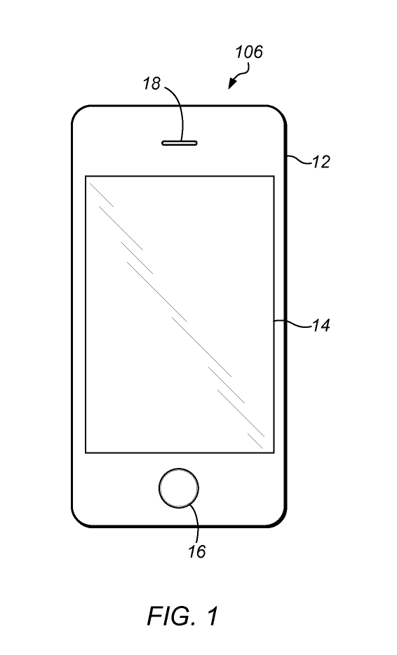

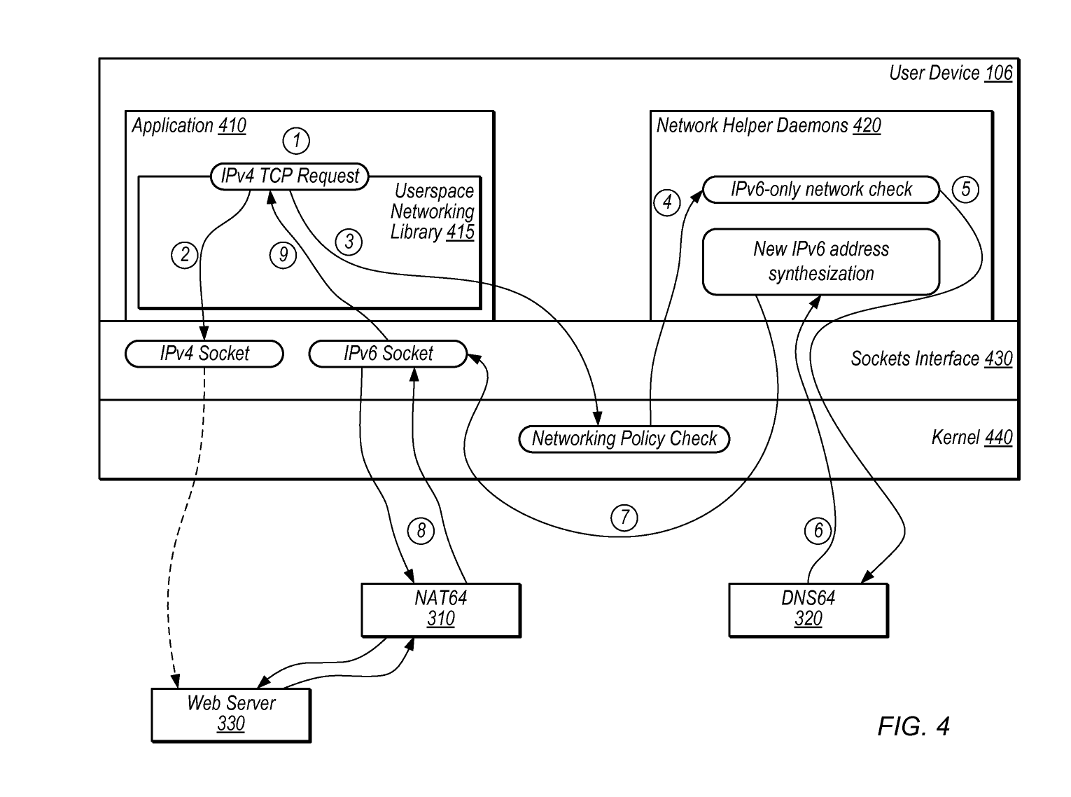

This disclosure initially lists relevant acronyms and a glossary. It then describes, with reference to FIGS. 1-3, an exemplary mobile device and communications between IPv6-only and IPv4 networks. Exemplary techniques for IPv4 literal translation are discussed with reference to FIGS. 4-7. In some embodiments, translation is performed on a per-connection or per-session basis. This may reduce power consumption and/or processing time relative to per-packet translation, for example.

### ACRONYMS

The following acronyms are used in the present disclosure.

3GPP: Third Generation Partnership Project

API: Application Programming Interface

BSD: Berkeley Software Distribution

CDMA: Code Division Multiple Access

DNS: Domain Name System

GSM: Global System for Mobile Communications

IP: Internet Protocol

LTE: Long Term Evolution

NAT: Network Address Translation

RAT: Radio Access Technology

RX: Receive

TCP: Transmission Control Protocol

TX: Transmit

UDP: User Datagram Protocol

UE: User Equipment

UMTS: Universal Mobile Telecommunications System

### TERMS

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, other handheld devices, as well as wearable devices such as wrist-watches, headphones, pendants, earpieces, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

### FIG. 1—User Equipment

FIG. 1 illustrates an example user equipment (UE) 106 (which may also be referred to as mobile device 106) according to some embodiments. UE device 106 may include a housing 12 which may be constructed from any of various materials. UE 106 may have a display 14, which may be a touch screen that incorporates capacitive touch electrodes. Display 14 may be based on any of various display technologies. The housing 12 of the UE 106 may contain or comprise openings for any of various elements, such as home button 16, speaker port 18, and other elements (not shown), such as microphone, data port, and possibly various other types of buttons, e.g., volume buttons, ringer button, etc.

The UE 106 may support multiple radio access technologies (RATs). For example, UE 106 may be configured to communicate using any of various RATs such as two or more of Global System for Mobile Communications (GSM), Universal Mobile Telecommunications System (UMTS), Code Division Multiple Access (CDMA) (e.g., CDMA2000 1×RTT or other CDMA radio access technologies), Long Term Evolution (LTE), LTE Advanced (LTE-A), and/or other RATs. For example, the UE 106 may support at least two radio access technologies such as LTE and GSM. Various different or other RATs may be supported as desired.

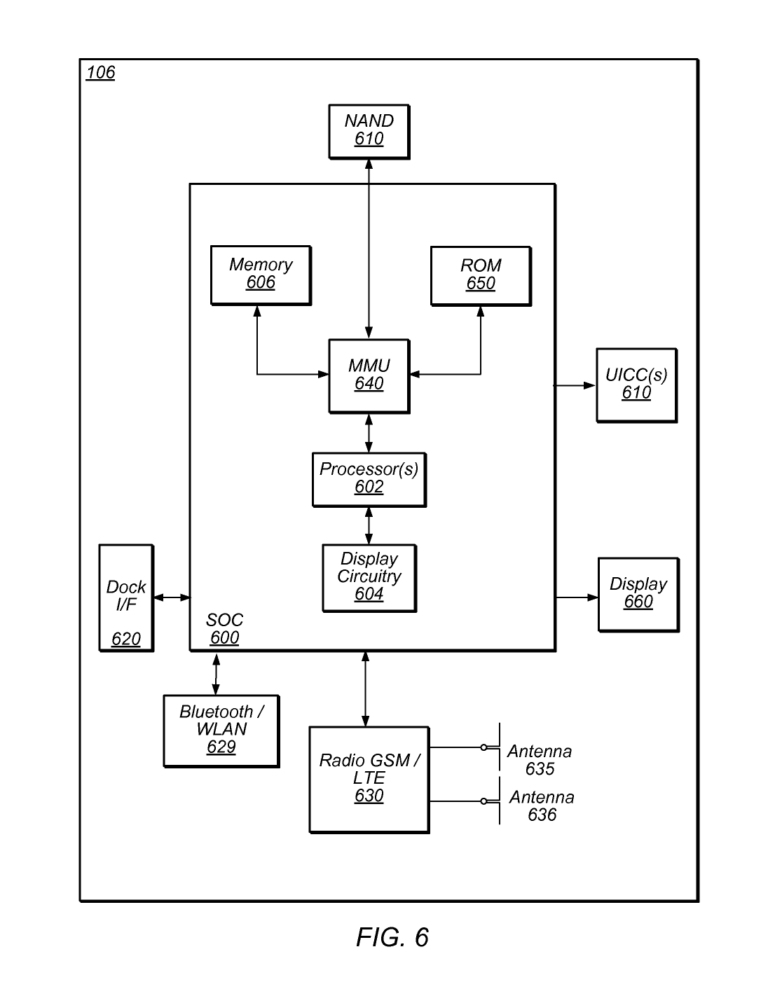

One or more antennas of UE 106 may receive a wide range of frequencies such as from 600 MHz up to 3 GHz. In some embodiments, the UE 106 is configured to support LTE, W-CDMA (W), TDS-CDMA (T) and/or GSM (G) radio access technologies. FIG. 6, discussed in further detail below, is a block diagram of exemplary components included in mobile device 106, according to some embodiments.

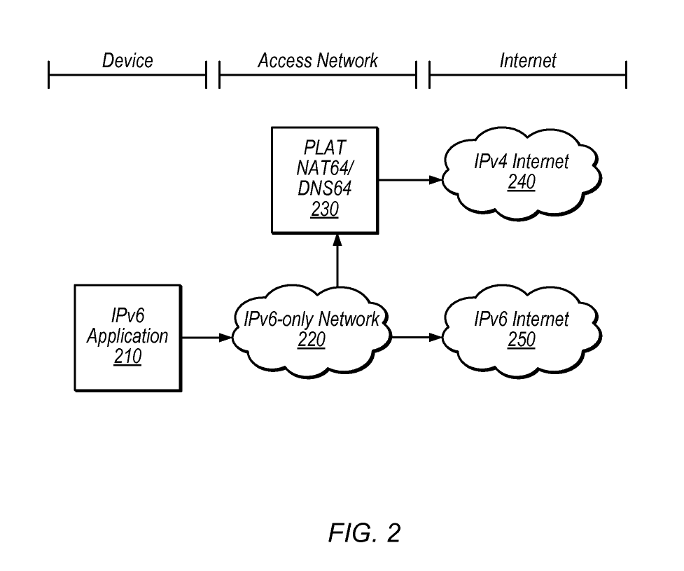

### FIG. 2—Overview of IPv6 and IPv4 Communications

FIG. 2 illustrates exemplary connectivity of an application 210 to different portions of the internet. In the illustrated embodiment, IPv6 application 210 is configured to communicate with both the IPv4 portion of the internet and the IPv6 portion of the internet via IPv6-only network 220. In the illustrated embodiment, IPv6-only network 220 is a cellular network provided by a cellular carrier. In other networks, the disclosed techniques may be implemented using any of various types of IPv6-only networks.

As shown, IPv6 application 210 is configured to communicate with the IPv6 internet (e.g., devices with IPv6 addresses) directly via the IPv6-only network 220. As shown, in the illustrated embodiment, the access network provides provider translation (PLAT) via NAT64/DNS64 to access the IPv4 internet (e.g., devices with IPv4 addresses and not IPv6 addresses). Various techniques discussed below may facilitate access to IPv4 internet 240, even in situations where traditional NAT64/DNS64 techniques may fail.

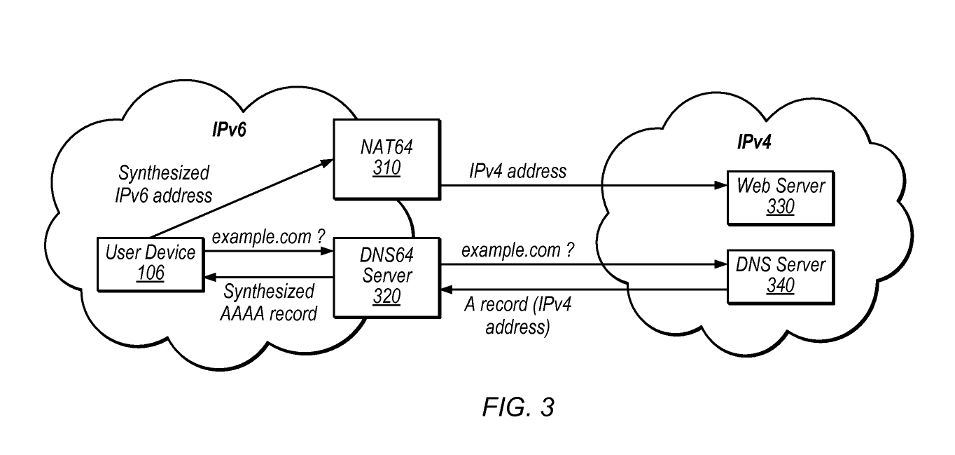

### FIG. 3—NAT64/DNS64 Overview

FIG. 3 illustrates an exemplary technique for communication using NAT64/DNS64. In the illustrated embodiment, user device 106 requests a website with the hostname “example.com” which is provided by web server 330. User device 106, in the illustrated embodiment, is coupled to an IPv6-only network. Web server 330, in the illustrated embodiment, does not have an IPv6 address.

In response to the request, DNS64 server 320 requests an IPv6 AAAA record (a 128-bit value that maps a hostname to a 128-bit IPv6 address). DNS server 340 indicates that it cannot provide an AAAA record, so DNS64 server 320 requests and receives an IPv4 A record instead (which indicates a 32-bit IPv4 literal value such as “69.9.64.11,” where each number in the value is represented using eight bits, for example).

DNS64 server 320 then synthesizes an AAAA record for the web server and provides the synthesized record to user device 106. In some embodiments, the synthesized address is formed as <96 bits of prefix use to route traffic to NAT64 310>: <32 bits of the IPv4 address of the IPv4-only destination>. The user device then communicates with web server 330 via NAT64 310 using the synthesized IPv6 address. NAT64, in some embodiments, is configured to interface between an IPv4 network and an IPv6 network and map traffic between the two (e.g., by performing translations for packets). NAT64 may be configured to perform stateless and/or stateful translations between the IPv4 and IPv6 networks.

Unfortunately, many applications (including web browsers, web applications, mobile applications, etc.) may specify IPv4 addresses using IPv4 literals (e.g., “69.9.64.11”) rather than using hostnames (e.g., example.com). In these situations, DNS may not be implicated and these applications may fail to reach web server 330 even in networks with DNS64/NAT64 (e.g., because IPv6 address synthesis never occurs).

One proposed technique to handle IPv4 literals is called 464XLAT, which is described in RFC 6877, M. Mawatari, “464XLAT: Combination of Stateful and Stateless Translation,” April 2013, which is incorporated by reference herein in its entirety. 464XLAT uses a client side stateless translator (CLAT), at the socket level, to convert IPv4 packets into IPv6 packets to send to a NAT64 translator. For example, “when connecting to an IPv4 literal or IPv4 socket that require IPv4 connectivity, the CLAT function on the UE provides a private IPv4 address and IPv4 default route on the host for the application to reference and bind to. Connections sourced from the IPv4 interface are immediately routed to the CLAT function and passed to the IPv6-only mobile network, destined for the PLAT [(provider translator)].” Packets translated by 464XLAT, however, each see two network address translation (NAT) traversals: one locally on the client and one by NAT64 in the network. 464XLAT operates at a low level (e.g., below the transport layer) and it is not possible at these lower network layers to associate an IPv6 address with a higher-layer connection or session (e.g., a TCP connection) at the beginning of the connection. Thus, in 464XLAT, an IPv4 literal is re-translated by the device for each packet. This may increase power consumption and/or reduce communication speed relative to processing for non-literal IPv4 addresses.

Therefore, in some embodiments discussed in further detail below, an IPv6 prefix is provided at higher-level interfaces (e.g., at the transport later or higher) and associated with a connection when the connection is created. In these embodiments, IPv4 to IPv6 translation is performed on a per-transport-layer-connection basis rather than on a per-packet basis (e.g., the IPv4 literal identifier is translated once, up-front, for a given connection or session and the translation is used for multiple packets of the connection or session).

### FIG. 4—Exemplary Translation Technique at Transport Layer

FIG. 4 illustrates an exemplary technique for translating IPv4 literals, according to some embodiments. In the illustrated embodiment, user device 106 is coupled to NAT64 310 and DNS64 320 via an IPv6-only network. NAT64 310, in the illustrated embodiment, is coupled to web server 330 via an IPv4 network that does not support IPv6 addresses.

User device 106, in the illustrated embodiment, executes program code for application 410, network helper daemons 420, sockets interface 430, and kernel 440. In some embodiments, application 410 is configured to generate an IPv4 literal identifier. For example, application 410 may be a web browser and a user may enter an IPv4 literal as a desired web page. As another example, application 410 may be a non-browser application configured to generate the IPv4 literal based on some user action (e.g., beginning a video chat, selecting an option to download app data, etc.). In the illustrated embodiment, application 410 implements a userspace networking library 415.

Network helper daemons 420, in some embodiments, may run as background processes and thus may not be under the direct control of user code (e.g., other than invoking an appropriate daemon directly or indirectly). In some embodiments, userspace networking library 415 is under control of (e.g., included in or called by) an application in the user space such as application 410.

At step (1) in the illustrated example, the IPv4 TCP request is generated. Application 410 may use an application programming interface (API) above sockets interface 430 to indicate its intent to create a transport layer connection (e.g., a TCP or a UDP connection, among others) to an IPv4 address literal.

At step (2) in the illustrated example, userspace networking library 415 attempts to connect to the IPv4 literal address. In most cases the attempt will fail (e.g., unless the IPv4 literal is a link-local address).

At step (3) in the illustrated example, which may be performed concurrently with step (2), userspace networking library 415 creates a policy check at the kernel 440 level.

At step (4) in the illustrated example, based on the created policy check, a network helper daemon 420 checks the state of the device and detects whether the connection is going over an interface (e.g., a cellular network) that supports IPv6 but not IPv4.

At step (5) in the illustrated example, the network helper daemon 420 creates a DNS query to “ipv4only.arpa,” a reserved name use to query DNS64 320 to determine the prefix used to synthesize IPv6 addresses (e.g., such that traffic with the prefix is routed through NAT64 server 310). In some embodiments, network helper daemon 420 determines the prefix from one or more received AAAA records using the techniques discussed in RFC 7050, T. Savolainen, “Discovery of the IPv6 Prefix Used for IPv6 Address Synthesis,” November 2013, which is incorporated by reference herein in its entirety. In other embodiments, other techniques may be used to determine the prefix.

At step (6) in the illustrated example, once the network helper daemon 420 receives a record from DNS64 server 320 (or from a local cache), it synthesizes a new IPv6 address using the determined prefix (which directs traffic to NAT64 server 310) and the 32-bit IPv4 address of web server 330. This may include using the prefix for the upper 92 bits of the address and the IPv4 address for the lower 32 bits of the address.

At step (7) in the illustrated example, the network helper daemon 420 sends a message back to application 410 indicating that it should try to connect with the synthesized IPv6 address. The message may include the synthesized IPv6 address.

At step (8) in the illustrated example, the application 410 creates a new transport layer connection to the synthesized IPv6 address via an IPv6 socket in sockets interface 430. In some embodiments, packets generated to the synthesized address are received by the NAT64 server 310, which is configured to translate back to IPv4 and transmit the packets to web server 330.

In some embodiments, the two concurrent connection attempts (as initiated in step (1) and step (8)) are raced, e.g., similarly to the well-known happy eyeballs technique. In these embodiments, once one of the attempts successfully connects, the other connection is closed and the successful connection is sent back to application 410. At step (9), in the illustrated embodiment, the successful connection via NAT64 310 is provided to application 410 for communication with web server 330.

The example of FIG. 4 is not intended to limit the scope of the present disclosure. Various steps may be performed by other circuitry or software modules in addition to and/or in place of the elements shown in FIG. 4. In various embodiments, the disclosed techniques for translating IPv4 literals on a per-connection or per-session basis may reduce power consumption and/or processing time.

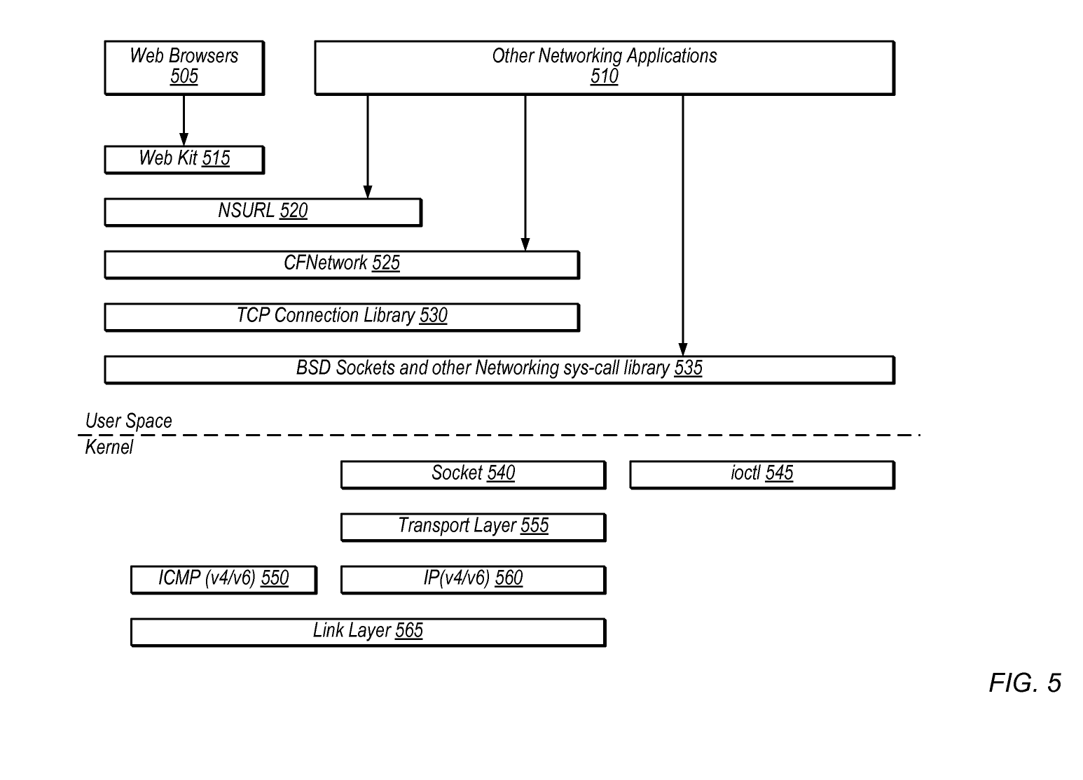

### FIG. 5—Exemplary Network Interfaces

FIG. 5 illustrates interfaces available to web browsers 505 and other networking applications 510. In the illustrated embodiment, interfaces in the user space include web kit 515, NSURL 520, CFNetwork 525, TCP Connection Library 530, and BSD Sockets and other Networking Sys-call library 535. In the illustrated embodiment, layers in the kernel space include a session layer (which includes socket 540 and input/output control (ioctl) for network devices 545), a transport layer 555 (which may include TCP and UDP, for example), a network layer (which includes Internet Control Message Protocol (ICMP) 550 and IP layer 560), and a link layer 565.

As discussed above, in some embodiments mobile device 106 may initially translate an IPv4 literal for a session or connection at transport layer 555 and use the translation (e.g., the synthesized IPv6 address) for subsequent communications using the session or connection. In some embodiments, this functionality is available to web browsers 505 and/or other networking applications 510 via various interfaces in the user space. For example, the functionality may be available using CFNetwork 525 or TCP connection library 530, in some embodiments. In other embodiments, the disclosed techniques for IPv4 translation may be performed by an application such as application 410 or any of various appropriate libraries or APIs not shown. In various embodiments, presence of a layer between an application and the sockets interface may allow address substitution at the start of a connection rather than on a per-packet basis.

Web kit 515, in some embodiments, is a layout engine software component configured to render web pages.

NSURL 520, in some embodiments, is a class configured to hold a uniform resource locator (URL). In some embodiments, it includes a URL loading system configured to present remote resources as data in memory or download remote resources to a local file system. In some embodiments, it specifies remote resources using URLs as set out in RFC 2396.

CFNetwork 525, in some embodiments, is an extension to traditional socket APIs with run-loop integration, for example. CFNetwork 525, in some embodiments is configured to work with IPv4 and IPv6 addresses in a way that is transparent to the user (e.g., using networking daemons, etc.). After resolving a CFNetwork host, sockets may be opened for further communication.

TCP connection library 530 and BSD sockets/sys-call library 535 may provide lower-level access to network functionality.

### FIG. 6—Mobile Device

FIG. 6 illustrates an example simplified block diagram of a mobile device 106. As shown, the UE 106 may include a system on chip (SOC) 600, which may include portions for various purposes. The SOC 600 may be coupled to various other circuits of the UE 106. For example, the UE 106 may include various types of memory (e.g., including NAND flash 610), a connector interface 620 (e.g., for coupling to a computer system, dock, charging station, etc.), the display 660, cellular communication circuitry 630 such as for LTE, GSM, etc., and short range wireless communication circuitry 629 (e.g., Bluetooth and WLAN circuitry). The UE 106 may further comprise two or more smart cards 610 that each comprise SIM (Subscriber Identity Module) functionality, such as two or more UICC(s) (Universal Integrated Circuit Card(s)) 610. The cellular communication circuitry 630 may couple to one or more antennas, preferably two antennas 635 and 636 as shown. The short range wireless communication circuitry 629 may also couple to one or both of the antennas 635 and 636 (this connectivity is not shown for ease of illustration).

As shown, the SOC 600 may include processor(s) 602 which may execute program instructions for the UE 106 and display circuitry 604 which may perform graphics processing and provide display signals to the display 660. The processor(s) 602 may also be coupled to memory management unit (MMU) 640, which may be configured to receive addresses from the processor(s) 602 and translate those addresses to locations in memory (e.g., memory 606, read only memory (ROM) 650, NAND flash memory 610) and/or to other circuits or devices, such as the display circuitry 604, cellular communication circuitry 630, short range wireless communication circuitry 629, connector I/F 620, and/or display 660. The MMU 640 may be configured to perform memory protection and page table translation or set up. In some embodiments, the MMU 640 may be included as a portion of the processor(s) 602.

The processor 602 of the UE device 106 may be configured to implement part or all of the features described herein, e.g., by executing program instructions stored on a memory medium (e.g., a non-transitory computer-readable memory medium). Alternatively (or in addition), processor 602 may be configured as a programmable hardware element, such as an FPGA (Field Programmable Gate Array), or as an ASIC (Application Specific Integrated Circuit). Alternatively (or in addition) the processor 602 of the UE device 106, in conjunction with one or more of the other components 600, 604, 606, 610, 620, 630, 635, 640, 650, 660 may be configured to implement part or all of the features described herein.

In various embodiments, program instructions executable to perform disclosed operations may be stored on a non-transitory computer-readable medium. In some embodiments, the program instruction are executable by a computing device to perform the operations. As used herein, the term “executable” includes program instructions that for code that must be enabled, turned on, called by a function (e.g., when provided as part of an API), etc. In other words, even though the functionality specified by the program instructions may be temporarily disabled, the program instructions are still executable to perform the operations that they specify. In some embodiments, the program instructions are included in a library of networking functions available for use by various applications.

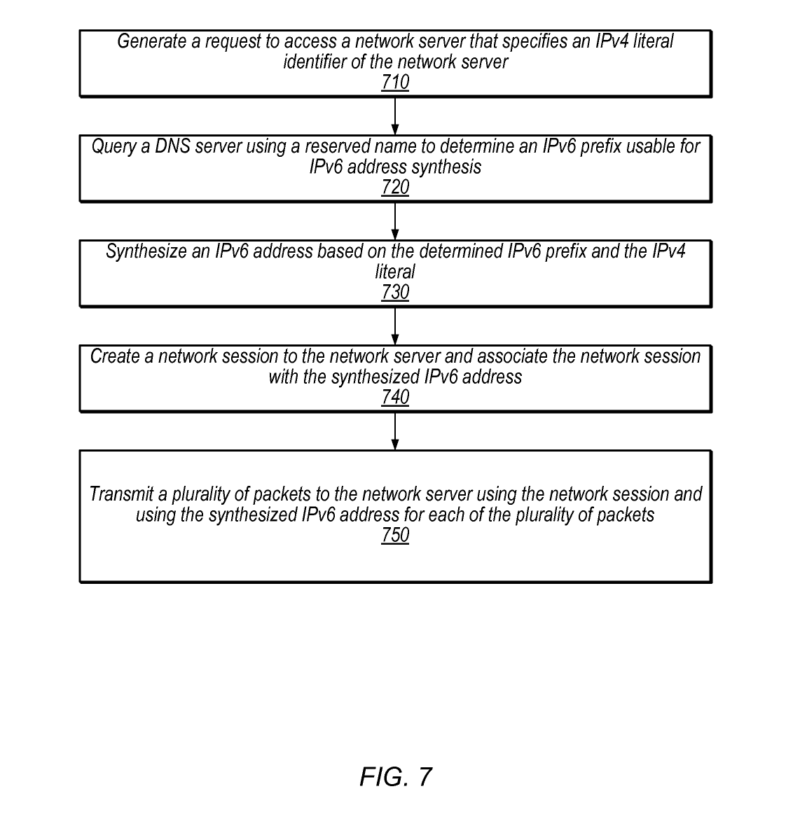

### FIG. 7—Exemplary Method

FIG. 7 is a flow diagram illustrating a method for IPv4 literal translation, according to some embodiments. The method shown in FIG. 7 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired. Flow begins at 710.

At 710, in the illustrated embodiment, mobile device 106 generates a request to access a network server. In these embodiments, the request specifies an IPv4 literal identifier of the network server. In some embodiments, the request does not specify a hostname of the network server. The generating may be performed in response to user input (e.g., entering the IPv4 literal into a browser or making a selection in an application that generates an IPv4 literal). In some embodiments, the network server is on an IPv4 network that does not support IPv6 addresses and the mobile device 106 is on an IPv6-only network.

At 720, in the illustrated embodiment, mobile device 106 queries a DNS server (e.g., DNS server 64 320) using a reserved name to determine an IPv6 prefix usable for IPv6 address synthesis. Mobile device 106 may determine the prefix based on a response from the DNS server.

At 730, in the illustrated embodiment, mobile device 106 synthesizes an IPv6 address based on the determined IPv6 prefix and the IPv4 literal. In some embodiments, this includes generating an IPv6 address by appending the IPv4 literal to the IPv6 prefix.

At 740, in the illustrated embodiment, mobile device 106 creates a network session (e.g., a transport layer session) to the network server and associates the network session with the synthesized IPv6 address. In some embodiments, the associating is performed at the beginning of the network session and the IPv6 address is used throughout the network session. In some embodiments, the transport layer session is a TCP or UDP connection. In various embodiments, network sessions or connections may be established at other layers in addition to and/or in place of the transport layer, using the synthesized IPv6 address.

At 750, in the illustrated embodiment, mobile device 106 transmits a plurality of packets to the network server using the network connection and using the synthesized IPv6 address for each of the plurality of packets. In some embodiments, the transmitting is performed via a NAT server for routing communications between an IPV6 network of mobile device 106 and an IPv4 network of the network server. In some embodiments, the transmission uses the synthesized IPv6 address for each of the plurality of packets without re-translating the IPv4 literal for ones of the plurality of packets. This may reduce power consumption and/or processing time relative to implementations such as 464XLAT which translate an IPv4 literal on a per-packet basis.

Mobile device 106 is discusses for illustrative purposes but is not intended to limit the scope of the present disclosure. In other embodiments, various types of mobile or non-mobile devices may be used on various types of IPv6-only networks, which may or may not be wireless. For example, similar techniques may be used with desktop computers and broadband cable data networks, etc.

Embodiments described in this disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A mobile device, comprising:
at least one antenna;
one or more radios coupled to the at least one antenna;
one or more processing elements; and
one or more memories having program instructions stored thereon, wherein the program instructions are executable by the one or more processing elements to cause the mobile device to perform operations comprising:
generating a request to access a network server, wherein the request specifies an Internet Protocol version 4 (IPv4) literal identifier of the network server;
querying a domain name system (DNS) server using a reserved name, to determine an IPv6 prefix usable for IPv6 address synthesis;
synthesizing an IPv6 address based on the determined IPv6 prefix and the IPv4 literal identifier;
creating a transport layer connection to the network server and associating the synthesized IPv6 address with the transport layer connection; and
transmitting, using the transport layer connection, a plurality of packets to the network server via a network address translation (NAT) server, wherein the transmitting uses the synthesized IPv6 address for each of the plurality of packets.

2. The mobile device of claim 1, wherein the transport layer connection is at least one of a transmission control protocol (TCP) connection or a user datagram protocol (UDP) connection.

3. The mobile device of claim 1, wherein the IPv4 literal identifier is not re-translated by the device for ones of the plurality of packets.

4. The mobile device of claim 1, wherein network traffic with the prefix is routable to the NAT server, wherein the NAT server is for routing communications between an Internet Protocol version 6 (IPv6) network of the device and an IPv4 network of the network server.

5. The mobile device of claim 1, wherein the operations further comprise:
executing an application, wherein the executing causes the generating;
utilizing an application programming interface (API) to determine the IPv6 prefix and synthesize the IPv6 address; and
utilizing a socket interface to process packets of the transport layer connection.

6. The mobile device of claim 1, wherein the reserved name of the DNS server is ipv4only.arpa.

7. The mobile device of claim 1, wherein the operations further comprise:
generating a request to access a second network server, wherein the request specifies an Internet Protocol version 4 (IPv4) hostname of the second network server;
requesting a record for the second network server from the DNS server, wherein the DNS server is a DNS64 server;
receiving a synthesized IPv6 record for the second network server from the DNS64 server; and
initiating a connection to the second network server, via the NAT server, using the synthesized IPv6 record.

8. A method, comprising:
generating, by a device, a request to access a network server, wherein the request specifies an Internet Protocol version 4 (IPv4) literal identifier of the network server;
querying, by the device, a domain name system (DNS) server using a reserved name, to determine an IPv6 prefix usable for IPv6 address synthesis;
synthesizing, by the device, an IPv6 address based on the determined IPv6 prefix and the IPv4 literal identifier;
creating, by the device, a network session to the network server and associating the network session with the synthesized IPv6 address; and
transmitting, by the device using the network session, a plurality of packets to the network server, wherein the transmitting uses the synthesized IPv6 address for each of the plurality of packets.

9. The method of claim 8, wherein the network session is a transmission control protocol (TCP) connection and wherein the IPv4 literal identifier is not re-translated by the device for ones of the plurality of packets.

10. The method of claim 8, wherein the transmitting includes transmitting the packets via a cellular IPv6-only carrier network.

11. The method of claim 8, wherein the transmitting is performed via a NAT64 server and wherein the DNS server is a DNS64 server.

12. The method of claim 8, further comprising:
executing, by the device, an application that generates the request; and
utilizing an application programming interface (API) to synthesize the IPv6 address.

13. The method of claim 8, wherein the reserved name is ipv4only.arpa.

14. The method of claim 8, further comprising:
generating, by the device, a request to access a second network server, wherein the request specifies an Internet Protocol version 4 (IPv4) hostname of the second network server;
requesting a record for the second network server from the DNS server, wherein the DNS server is a DNS64 server;
receiving a synthesized IPv6 record for the second network server from the DNS64 server; and
initiating a connection to the second network server and associating the connection to the second network server with the synthesized IPv6 record for the second network server.

15. A non-transitory computer-readable medium having instructions stored thereon that are executable by a computing device to perform operations comprising:
generating a request to access a network server, wherein the request specifies an Internet Protocol version 4 (IPv4) literal identifier of the network server;
querying a domain name system (DNS) server using a reserved name, to determine an IPv6 prefix usable for IPv6 address synthesis;
synthesizing an IPv6 address based on the determined IPv6 prefix and the IPv4 literal identifier;
creating a transport layer session to the network server using the synthesized IPv6 address; and
transmitting, using the transport layer session, a plurality of packets to the network server via a network address translation (NAT) server, wherein the transmitting uses the synthesized IPv6 address for each of the plurality of packets, and wherein the IPv4 literal identifier is not re-translated by the device for ones of the plurality of packets.

16. The non-transitory computer-readable medium of claim 15, wherein the instructions are specified by an application programming interface.

17. The non-transitory computer-readable medium of claim 15, wherein the instructions are included in a networking library.

18. The non-transitory computer-readable medium of claim 15, wherein the NAT server is a NAT64 server and the DNS server is a DNS64 server, wherein network traffic with the prefix is routable to the NAT server, and wherein the NAT server is for routing communications between an Internet Protocol version 6 (IPv6) network of the device and an IPv4 network of the network server.

19. The non-transitory computer-readable medium of claim 15, wherein the operations further comprise:
generating a request to access a second network server, wherein the request specifies an Internet Protocol version 4 (IPv4) hostname of the second network server;
requesting a record for the second network server from the DNS server, wherein the DNS server is a DNS64 server;
receiving a synthesized IPv6 record for the second network server from the DNS64 server; and
initiating a connection to the second network server, via the NAT server, using the synthesized IPv6 record.

20. The non-transitory computer-readable medium of claim 15, wherein the transmitting is performed via an IPv6-only network.
